(19) United States
(12) Patent Application Publication
(10) Pub. No.: US 2011/0291385 A1
(43) Pub. Date: Dec. 1, 2011

(54) Apparatus for Universal Rear Impact Guard Connection Adapter Plate

(76) Inventors: Earl DORSEY, Oak Brook, IL (US); Eric Teram Hudson, SR., Bellwood, IL (US)

(21) Appl. No.: 12/876,924

(22) Filed: Sep. 7, 2010

Related U.S. Application Data
(60) Provisional application No. 61/368,985, filed on Jul. 29, 2010.
(60) Provisional application No. 61/349,241, filed on May 28, 2010.

(51) Int. Cl. B60D 1/34

(52) U.S. Cl. 280/507

(57) ABSTRACT

The present invention is a multi-use rear impact guard connecting adapter. It is used to connect the user's vehicle to a freight carrier, such as a dolly, trailer, another vehicle, etc. The unique adapter plate of the present invention provides a more stable and durable link from one vehicle to another.

The current application claims a priority to the U.S. Provisional Patent application Ser. No. 61/368,985 filed on Jul. 29, 2010.

### FIELD OF THE INVENTION

The present invention relates generally to a rear connecting guard. More particularly, its objective provides a connector for the rear guard of a vehicle to a freight carrier or another vehicle.

### BACKGROUND OF THE INVENTION

Towing connectors used to connect the user's truck, trailer, van or other such vehicle to a similar vehicle or freight carrier serve to not only connect the user's vehicle to freight devices, but also to provide stability, control, and safety. A number of cases have risen wherein the cargo attached to the user's vehicle either falls off the connector or is stolen by cargo thieves. In either case, both are caused by a weak or poorly constructed connector. Either the towing connector has a weak structure or the connector can be easily dismantled. A connector such as the ball hitch that comprises a ball hitch attached to the user's vehicle and is then connected to the cargo vehicle by a ball mount is an example of an unreliable hitch mechanism. The ball mount can easily be knocked off the hitch ball when the user accidentally drives over a significantly large bump on the terrain, in which case the cargo is left behind. The present invention provides the stability and durability the user needs for a secure attachment for the cargo carrier to the user's vehicle given variable terrain.

### BRIEF DESCRIPTION OF THE DRAWINGS

FIG. 1 is a perspective view of the present invention.

FIG. 2 is an exploded view of the present invention.

FIG. 3 is the front elevational view of the present invention.

FIG. 4 is the rear elevational view of the present invention.

FIG. 5 is the left elevational view of the present invention.

FIG. 6 is the right elevational view of the present invention.

FIG. 7 is the bottom plan view of the present invention.

FIG. 8 is the top plan view of the present invention.

### DETAIL DESCRIPTIONS OF THE INVENTION

All illustrations of the drawings are for the purpose of describing selected versions of the present invention and are not intended to limit the scope of the present invention.

The present invention provides the stability and endurance needed for vehicles intending to connect and tow freights or other vehicles behind. Its function is to allow a temporary connection point on semi-trailers and tandem trailers for various types of implements including, but not limited to, stabilizer bars, bumper pads and other attachments. The present invention is able to accept different types of mounts to connect a trailer or multi-rig van to a converted dolly. It is designed for trucking, specifically, to hook up trucks that are double or triple its weight to move freight. One of the most unique aspects of the present invention is that it hooks to a “breakaway bumper”.

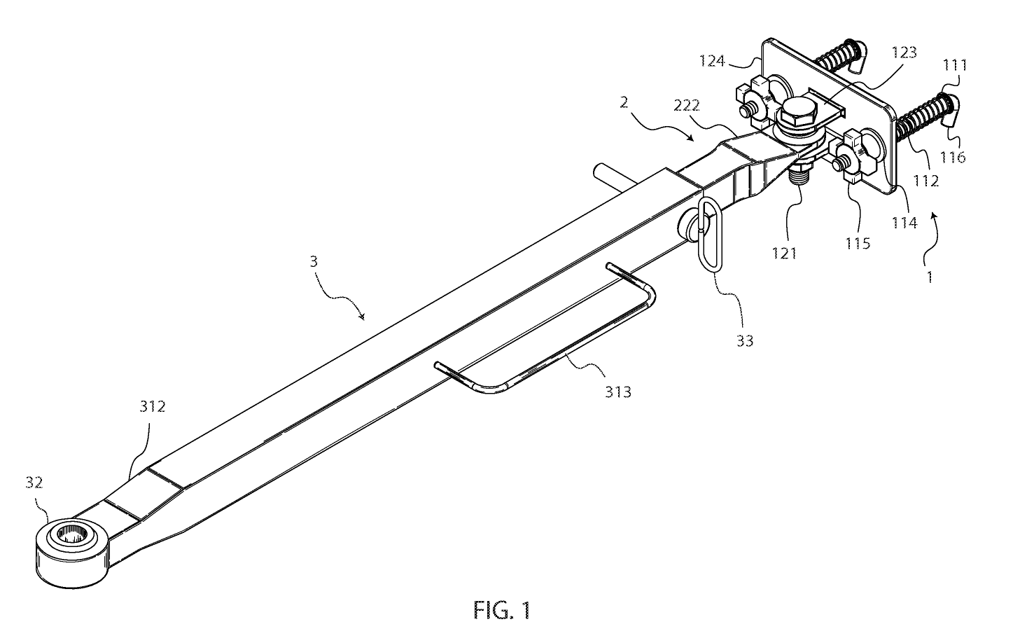

The present invention is depicted as shown in FIG. 1. There are three divisions of the present invention: a hitch adapter 1, a guard arm 2, and a guard arm sleeve 3. In reference to FIG. 1, the hitch adapter 1 is connected to the guard arm sleeve 3 by the guard arm 2.

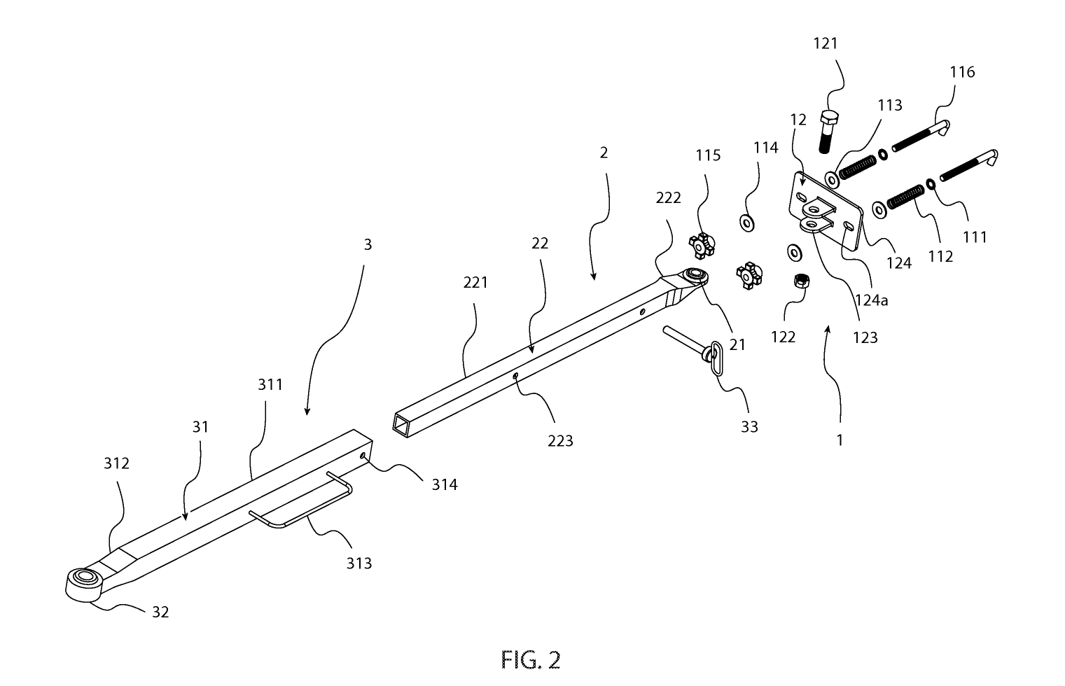

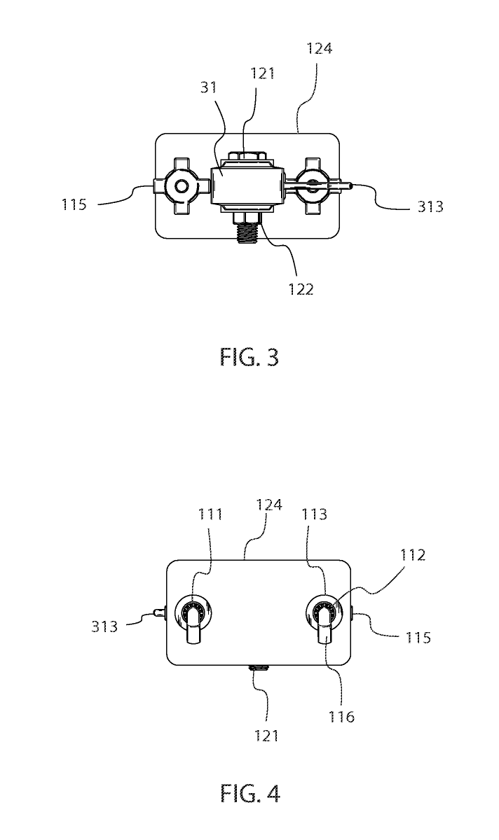

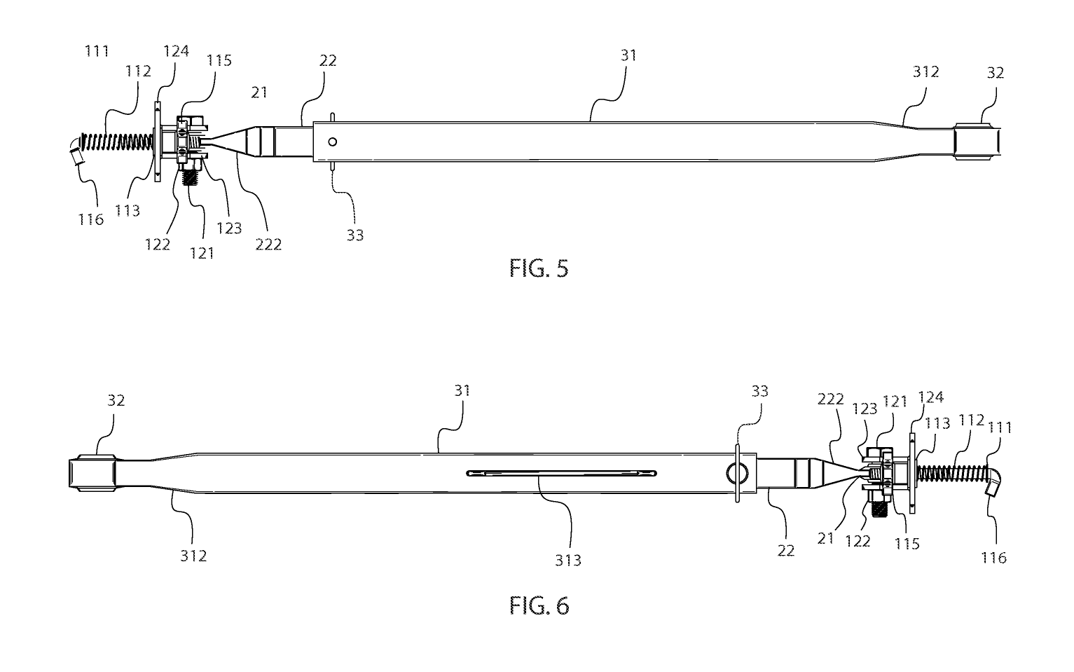

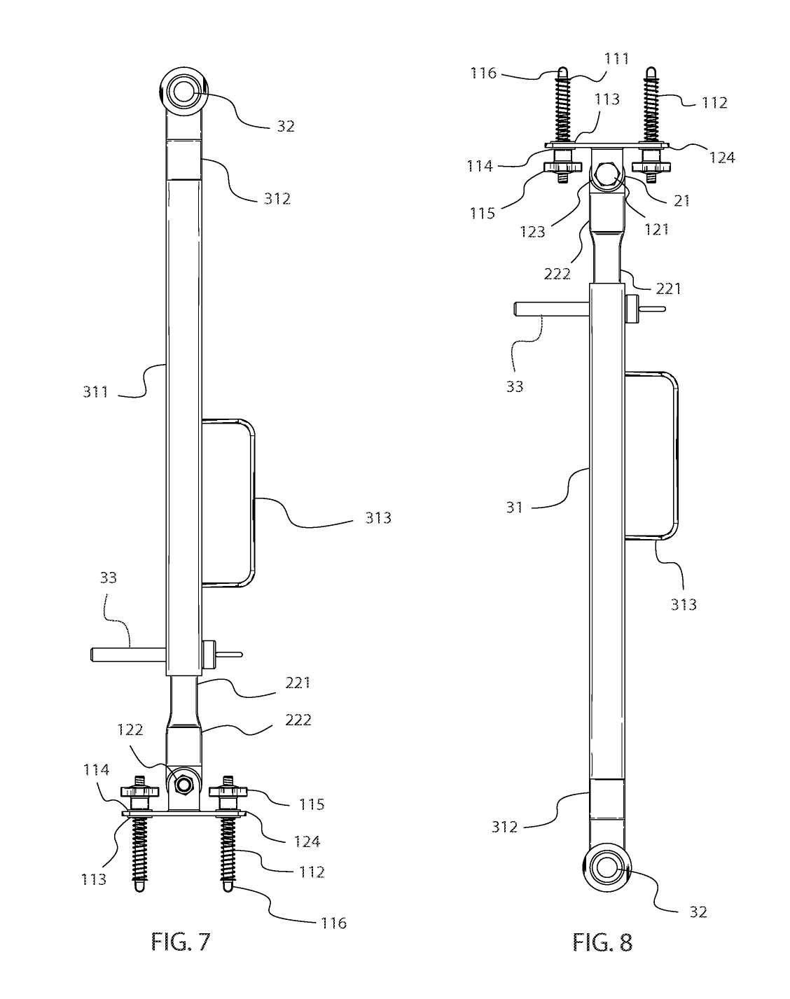

The hitch adapter 1 is comprised of an L-hook 11 and a hitch adapter joint 12. First, the hitch adapter joint 12 comprises a hex head bolt 121, a hex nut 122, and a hitch adapter plate 124, which comprises slotted holes 123 and plate holes 124a. As illustrated in FIG. 2, the slotted holes 123 are connected to the hitch adapter plate 124 in a perpendicular relation. The slotted holes 123 exist to provide a bracketed gap wherein the guard arm 2, which comprises the first eye hole joint 21, is inserted. With the guard arm's 2 first eye hole joint inserted within the slotted holes 123, the hex head bolt 121 is concentrically and internally fitted through the slotted holes 123, the first eye hole joint 21, and the hex nut 122. The hitch adapter joint 12 serves to join the user's vehicle to the dolly by providing a degree of freedom of motion.

The other component of the hitch adapter 1 is the L-hook 11. The L-hook 11 acts as a hook clinging onto the user's vehicle's “breakaway bumper”. The L-hook 11 comprises locking washers 111, springs 112, first-set washers 113, second-set washers 114, L-bolt fasteners 115, and L-bolts 116. These components serve to fasten the present invention to the user's vehicle. The locking washers 111, springs 112, first-set washers 113, plate holes 124a, second-set washers 114, and the L-bolt fasteners 115 concentrically and peripherally fit onto the L-bolts 116. The springs 112 provide a buffer for the impact from the momentum of the dolly or towed vehicle. Hence, the springs 112 function to provide a guard for the user's vehicle—the impact guard. While they are fitted onto the L-bolts 116, the locking washers 111 are connected adjacently to the first-set washers 113 by the springs 112. The first-set washers 113 are then connected adjacently to the second-set washers 114 by the hitch adapter plate 124. Completing the L-hook 11 of the present invention are the L-bolt fasteners 115, which are fastened to the L-bolts 116. The locking washers 111, the first-set washers 113, second-set washers 114, and L-bolt fasteners 115 ensure security of the L-bolts 116 by eliminating mechanical slack and preventing the nearby components from disengaging.

To provide the length in between the two vehicles for the present invention is the guard arm 2 and the guard arm sleeve 3. The guard arm 2 is comprised of a guard arm body 22 and, as aforementioned, the first eye hole joint 21. The guard arm body 22 comprises a hollowed rectangular bar 221, a tapered end 222, and body holes 223. The first eye hole joint 21 is attached to the hollowed rectangular bar 221 by the tapered end 222. As shown in FIG. 2, the body holes 223 are positioned in perpendicular relation to the slotted holes 123 and the hitch adapter plate 124 of the hitched adapter joint 12 on the hollowed rectangular bar 221.

The guard arm sleeve 3 comprises an eye hole joint opening 32, a bar spring load pin 33, and a sleeve body 31, which consists of a sleeve hollowed rectangular bar 311, a wide tapered end 312, a handle 313, and sleeve holes 314. The sleeve body's 31 purpose is to provide an adjustable means for the present invention, adding or decreasing the length desired for appropriate travel with a freight carrier by fitting peripherally around the guard arm body 22. The sleeve hollowed rectangular bar 311 is peripherally fitted onto the hollowed rectangular bar 221 of the guard arm body 22. The handle 313 is connected in perpendicular relation to the slotted holes 123 and the hitch adapter plate 124 on the sleeve hollowed rectangular bar 311, and the sleeve holes 314 are also positioned adjacently to the handle 313 on the sleeve hollowed rectangular bar 311. The handle 313 provides convenience to the user when using the present invention. When the present invention is not in use, the user is able to carry the invention by the handle 313. During installation of the present invention, the user can use the handle 313 to adjust and hold the entire apparatus in place. A bar spring load pin 33 is fitted concentrically through the sleeve holes 314 and the body holes 223. The bar spring load pin 33 provides the locking mechanism required to secure together the guard arm 2 and guard arm sleeve 3. Additionally, the bar spring load pin 33 locks the present invention at its desired length. This feature gives the present invention the versatility to accept different types of mounts with different lengths. The sleeve hollowed rectangular bar 311 is connected to the eye hole joint opening 32 by the wide tapered end 312. The eye hole joint opening 32 is what connects to the freight carrier mount by a standard mount hitch pin. The eye hole joint opening 32 has a cylindrical hole to fit the mount hitch pin. By connecting to the freight carrier, the present invention allows the user to sturdily connect moving vehicles such as trucks or trailers to a freight attachment. Additionally, the present device can be adapted to fit several different types of connections, allowing the user to save time and money by only having to obtain this one connection adapter. Thus, the user does not have to acquire several different connectors which may end up costing a large amount of money. Furthermore, the user of the present invention is saved the difficulty of having to carry several different connectors. Instead, the user can simply utilize the present invention to accomplish all the connection needs.

Although the invention has been explained in relation to its preferred embodiment, it is to be understood that many other possible modifications and variations can be made without departing from the spirit and scope of the invention as hereinafter claimed.

What is claimed is:

1. An apparatus for a universal rear impact guard connection adapter plate comprises,
a hitch adapter;
a guard arm;
a guard arm sleeve;
the hitch adapter being connected to the guard arm sleeve by the guard arm;
the hitch adapter comprises an L-hook and a hitch adapter joint;
the guard arm comprises a first eye hole joint and a guard arm body;
the guard arm sleeve comprises a sleeve body, a bar spring load pin, and a eye hole joint opening;
the hitch adapter joint comprises a hex head bolt, a hex nut, and a hitch adapter plate;
The hitch adapter plate comprises slotted holes and plate holes; and
the guard arm body comprising a body holes, a tapered end, and a hollowed rectangular bar.

2. The apparatus as claimed in claim 1 comprises,
the slotted holes being connected in perpendicular relation to the hitch adapter plate; and
the hex head bolt being concentrically and internally fitted through the slotted holes, the first eye hole joint, and the hex nut.

3. The apparatus as claimed in claim 1 comprises,
the L-hook comprises locking washers, springs, first-set washers, second-set washers, L-bolt fasteners, and L-bolts; and
the L-bolts being concentrically and internally fitted through the locking washers, the springs, the first-set washers, the plate holes, and the second-set washers.

4. The apparatus as claimed in claim 3 comprises,
the locking washers being connected in adjacent relation to the first-set washers by the springs;
the first-set washers being connected in adjacent relation to the second-set washers by the hitch adapter plate; and
the L-bolt fasteners being fastened to the L-bolts.

5. The apparatus as claimed in claim 1 comprises,
the first eye hole joint being connected to the hollowed rectangular bar by the tapered end; and
the body holes being positioned in perpendicular relation to the slotted holes and the hitch adapter plate on the hollowed rectangular bar.

6. The apparatus as claimed in claim 1 comprises,
the sleeve body comprising a sleeve hollowed rectangular bar, a wide tapered end, a handle, and sleeve holes;
the sleeve hollowed rectangular bar being peripherally fitted onto the hollowed rectangular bar;
the handle being connected in perpendicular relation to the slotted holes and the hitch adapter plate on the sleeve hollowed rectangular bar; and
the sleeve holes being positioned adjacent to the handle.

7. The apparatus as claimed in claim 6 comprises,
the bar spring load pin fitting concentrically through the sleeve holes and the body holes; and
the sleeve hollowed rectangular bar being connected to the eye hole joint opening by the wide tapered end.

8. An apparatus for a universal rear impact guard connection adapter plate comprises,
a hitch adapter;
a guard arm;
a guard arm sleeve;
the hitch adapter being connected to the guard arm sleeve by the guard arm;
the hitch adapter comprises an L-hook and a hitch adapter joint;
the guard arm comprises a first eye hole joint and a guard arm body;
the guard arm sleeve comprises a sleeve body, a bar spring load pin, and a eye hole joint opening;
the hitch adapter joint comprises a hex head bolt, a hex nut, and a hitch adapter plate;
The hitch adapter plate comprises slotted holes and plate holes;
the guard arm body comprising a body holes, a tapered end, and a hollowed rectangular bar;
the L-hook comprises locking washers, springs, first-set washers, second-set washers, L-bolt fasteners, and L-bolts;
the first eye hole joint being connected to the hollowed rectangular bar by the tapered end; and
the sleeve body comprising a sleeve hollowed rectangular bar, a wide tapered end, a handle, and sleeve holes.

9. The apparatus as claimed in claim 8 comprises,
the slotted holes being connected in perpendicular relation to the hitch adapter plate; and
the hex head bolt being concentrically and internally fitted through the slotted holes, the first eye hole joint, and the hex nut.

10. The apparatus as claimed in claim 8 comprises,
the L-bolts being concentrically and internally fitted through the locking washers, the springs, the first-set washers, the plate holes, and the second-set washers.

11. The apparatus as claimed in claim 10 comprises,
the locking washers being connected in adjacent relation to the first-set washers by the springs;
the first-set washers being connected in adjacent relation to the second-set washers by the hitch adapter plate; and
the L-bolt fasteners being fastened to the L-bolts.

12. The apparatus as claimed in claim 8 comprises,
the body holes being positioned in perpendicular relation to the slotted holes and the hitch adapter plate on the hollowed rectangular bar.

13. The apparatus as claimed in claim 8 comprises,
the sleeve hollowed rectangular bar being peripherally fitted onto the hollowed rectangular bar;
the handle being connected in perpendicular relation to the slotted holes and the hitch adapter plate on the sleeve hollowed rectangular bar; and
the sleeve holes being positioned adjacent to the handle.

14. The apparatus as claimed in claim 13 comprises,
the bar spring load pin fitting concentrically through the sleeve holes and the body holes; and
the sleeve hollowed rectangular bar being connected to the eye hole joint opening by the wide tapered end.

15. An apparatus for a universal rear impact guard connection adapter plate comprises,
a hitch adapter;
a guard arm;
a guard arm sleeve;
the hitch adapter being connected to the guard arm sleeve by the guard arm;
the hitch adapter comprises an L-hook and a hitch adapter joint;
the guard arm comprises a first eye hole joint and a guard arm body;
the guard arm sleeve comprises a sleeve body, a bar spring load pin, and a eye hole joint opening;
the hitch adapter joint comprises a hex head bolt, a hex nut, and a hitch adapter plate;
The hitch adapter plate comprises slotted holes and plate holes;
the guard arm body comprising a body holes, a tapered end, and a hollowed rectangular bar;
the L-hook comprises locking washers, springs, first-set washers, second-set washers, L-bolt fasteners, and L-bolts;
the first eye hole joint being connected to the hollowed rectangular bar by the tapered end;
the sleeve body comprising a sleeve hollowed rectangular bar, a wide tapered end, a handle, and sleeve holes;
the locking washers being connected in adjacent relation to the first-set washers by the springs;
the body holes being positioned in perpendicular relation to the slotted holes and the hitch adapter plate on the hollowed rectangular bar;
the sleeve hollowed rectangular bar being peripherally fitted onto the hollowed rectangular bar;

16. The apparatus as claimed in claim 15 comprises,
the slotted holes being connected in perpendicular relation to the hitch adapter plate; and
the hex head bolt being concentrically and internally fitted through the slotted holes, the first eye hole joint, and the hex nut.

17. The apparatus as claimed in claim 15 comprises,
the L-bolts being concentrically and internally fitted through the locking washers, the springs, the first-set washers, the plate holes, and the second-set washers.

18. The apparatus as claimed in claim 17 comprises,
the first-set washers being connected in adjacent relation to the second-set washers by the hitch adapter plate; and
the L-bolt fasteners being fastened to the L-bolts.

19. The apparatus as claimed in claim 15 comprises,
the handle being connected in perpendicular relation to the slotted holes and the hitch adapter plate on the sleeve hollowed rectangular bar; and
the sleeve holes being positioned adjacent to the handle.

20. The apparatus as claimed in claim 19 comprises,
the bar spring load pin fitting concentrically through the sleeve holes and the body holes; and
the sleeve hollowed rectangular bar being connected to the eye hole joint opening by the wide tapered end.
